(19) United States
(12) Patent Application Publication
(10) Pub. No.: US 2005/0108905 A1
(43) Pub. Date: May 26, 2005

(54) Gift card and method of folding same

(76) Inventor: Eng Huat Png, People's Park Centre (SG)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 10/718,197

(22) Filed: Nov. 20, 2003

(51) Int. Cl. G09F 1/00

(52) U.S. Cl. 40/124.09

(57) ABSTRACT

This invention relates to a folded card that comprises a central portion and a pair of side flaps connected to either side of the central portion where the side flaps are folded over the central portion so that only a section of the central portion is covered. This allows an image or illustration to be printed onto the central portion so that not all of the image is visible when the card is folded.

### FIELD OF THE INVENTION

This invention relates to a novel card and a method of folding the card.

### BACKGROUND OF THE INVENTION

Cards generally consists of a single sheet of material that has been folded in two portions about a centre line. Typically pictures or drawings are printed on the front face, and a pre-printed message is written on inside surfaces of the card. There is an interest in novel designs for cards which differ from the typical card described above.

Therefore, it is an object of the present invention to provide a new card and method of folding the card.

### SUMMARY OF THE INVENTION

According to one aspect of the present invention, a folded card comprises:
a central portion; and
a pair of side flaps connected to either side of said central portion; wherein said side flaps are folded over said central portion so that only a section of said central portion is covered.

The central portion of the card may have image or illustration printed thereon. A feature of the invention is that the side flaps cover a portion of that image or illustration so that the image or illustration is only initially visible in the folded card in the uncovered section of the central portion. The full image or illustration only becomes visible upon unfolding the card.

Preferably, each of the side flaps further comprise an overlying flap that is folded back over the outer surface of each respective side flap. The folding of each overlying flap further exposes more of the central portion.

Preferably, the card is folded from a square sheet of material and each of the side flaps are triangular. Preferably, the fold lines between each side flap and central portion extend from one corner of the card to an opposite side of the square sheet. This results in a triangular side flap which preferably has an edge that extends to and is contiguous with the fold line of the adjacent side flap. Similarly, the opposite edge of the second side flap extends to and is contiguous with the fold line of the side flap that it overlies.

The underside surface of each of the side flaps may be coloured so that the coloured surface faces upwardly when the side flap is folded over the central portion. Similarly, the surface of the overlying flap which faces upwardly may be coloured so that this coloured surface becomes visible when the overlying flap is folded. Accordingly, in relation to the coloured surfaces on a sheet that is to be folded into the card, the coloured surfaces for the side flaps are on the underneath surface of the card and the coloured surface for the overlying flaps are on the upper surface of the card. This leaves a central portion which may have an image or illustration printed thereon which is then partially covered by the side and overlying flaps.

Although as mentioned above, the card may be folded from a square sheet of material, other shapes such as rectangular shapes or portions of the sheet having curved sections may be used to result in a variety of shapes of exposed central portions and side and overlying flaps.

A further aspect of the invention comprises a method of folding the card as described above wherein a first side flaps is folded over the central portion, the overlying flap of the first side flap is then folded, the second side flap is then folded over the first side flap and the overlying flap of the second side flap is then folded.

Another aspect of this invention is a sheet to be folded into a card according to a first aspect of this invention.

As mentioned above, an image or illustration may be printed onto the central portion. The invention also includes alternative displays such as attaching or adhering a photograph or graphical representation to the central portion.

A specific embodiment of the invention will now be described in some further detail with reference to and as illustrated in the accompanying drawings. These embodiments are illustrative, and are not meant to be restrictive of the scope of the invention.

### BRIEF DESCRIPTION OF THE DRAWINGS

This embodiment is illustrated in the accompanying drawings in which;

FIG. 1 shows a plan view of a planar sheet that is to be folded into a card;

FIGS. 2 to 4 show each step in folding a sheet shown in FIG. 1 into a card; and

FIG. 5 shows a folded card according to the invention.

### DETAILED DESCRIPTION

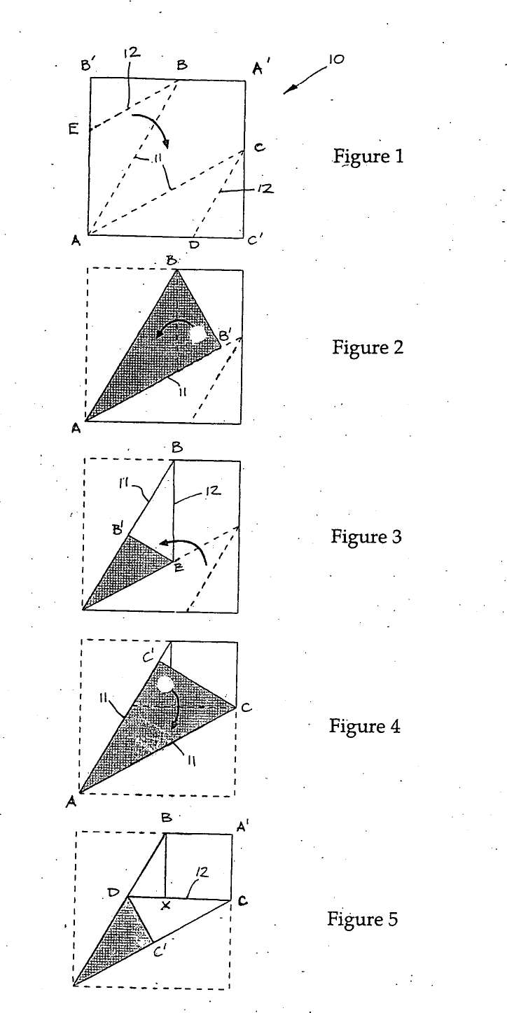

As shown in FIG. 1, the folded card starts as a square sheet 10 of card or paper. FIG. 1 shows first fold lines 11 that extend between the points A, B and A, C. Second fold lines 12 extend between points B, E and C, D.

The side flaps comprise triangular portions defined by points A, B, B′ and the points A, C, C′. As illustrated in FIG. 1, the side flap defined by the points A, B, B′ is folded over a central portion which is primarily defined by points A, A′, B, C. As seen in FIG. 2, the edge defined by the points A, B′ extends to and is contiguous with the adjacent fold line 11.

The overlying flap of the first flap, is then folded along the fold line 12 which extends between the points B, E as shown in FIG. 3. The edge of the overlying flap between points B, B′ extends to and is contiguous with the first fold line 11 (see FIG. 3). As shown in FIG. 4, the second side flap is folded about fold line 11 that extends between the points A, C. The edge A, C′ extends to and is contiguous with the first fold line 11.

The overlying flap of the second side flap is then folded along fold line 12 which is between points C, D. This then results in the finished folded card shown in FIG. 5.

FIG. 1 shows the upper surface of the square sheet 10. In this embodiment, the underneath surface of the side flaps defined by the points A, B, B′ and A, C, C′ are coloured. In this embodiment, the underneath surfaces of the side flaps may have different colours which become visible when the side flats are folded over the central portion.

The overlying flaps defined by points B, B′, E and C, C′, D may also be coloured on the upper surface of the sheet 10. This results in each of these coloured surfaces facing upwardly when the overlying sheets are folded back over the top of each of the side flaps. Again, each of the overlying flaps may have a different contrasting colour.

The central portion generally comprises the area defined by points A, C, A′, B. It is generally within this area that an image or illustration may be printed. However, portions of the image or illustration may be printed in the areas defined by the points A, C, D and A, B, E.

In folding the side and overlying flaps over the central portion, a portion, but not all, of the illustration or image is covered. In the finished card shown in FIG. 5, the only portion of the image visible is in the area defined by the points C, A′, B, X. The full image only becomes visible upon unfolding the card.

The card according to this invention provides a novel design which could appropriately incorporate an image of flowers on the central portion. The flowers that are visible in the card when it is folded give the appearance of a bouquet of flowers that are wrapped. As such, the invention fulfils the promise of providing a new type of card and a method of folding such a card.

1. A folded card formed from rectangular sheet material comprising:
a central portion; and
a pair of side flaps connected to either side of said central portion; wherein said side flaps are folded over said central portion so that only a section of said central portion is covered.

2. A folded card according to claim 1 wherein each of said flaps further comprise overlaying flaps that are folded back over each respective side flap.

3. A folded card according to claim 1 or claim 2 wherein the under side surface of said side flaps have a coloured surface so that said coloured surface faces upwardly when said side flap is folded over said central portion.

4. A folded card according to any one of the preceding claims wherein said overlaying flaps have a coloured surface so that said coloured surface faces upwardly when it is folded over said each respective side flap.

5. A folded card according to any one of the preceding claims further comprising an image or illustration printed on at least said central portion, said image or illustration being only partially covered by said side flaps so that a portion of said image or illustration remains visible.

6. A folded card according to any one of the preceding claims wherein said flaps are triangular.

7. A folded card according to any one of claims 2 to 6 wherein said overlying flaps are triangular.

8. A folded card according to any one of the preceding claims wherein said rectangular sheet material is square.

9. A folded card according to claim 8 wherein the fold line between said side flaps and said central portion extend from one corner of said square sheet material to opposite sides of said square sheet.

10. A folded card according to claim 9 wherein the fold line between each said side flap and respective overlying flaps extends from the point that the fold line between said side flap and said central portion intersects said opposite side to the opposite side of each said side flap.

11. A sheet to be folded into a card according to any one of the preceding claims.

12. A method of folding a card according to any one of claims 1 to 10 comprising:
folding a first side flap over said central portion;
folding said overlying flap of said first side flap;
folding the second side flap over said first side flap; and
folding said overlying flap of said second side flap.

13. A folding card substantially as hereinbefore described with reference to and as illustrated in the accompanying drawings.

14. A method of folding a card according to any one of claims 1 to 11 substantially as hereinbefore described with reference to and as illustrated in the accompanying drawings.
